(19) United States
(12) Patent Application Publication
(10) Pub. No.: US 2004/0180211 A1
(43) Pub. Date: Sep. 16, 2004

(54) Photochromic polyurethane film of improved fatigue resistance

(75) Inventors: Thomas J. Moravec, Maple Grove, MN (US); Michael S. Boulineau, Forest Lake, MN (US)

Correspondence Address: INSKEEP INTELLECTUAL PROPERTY GROUP, INC, 1225 W. 190TH STREET, SUITE 205, GARDENA, CA, 90248, US

(73) Assignee: Vision-Ease Lens, Inc.

(21) Appl. No.: 10/764,762

(22) Filed: Jan. 26, 2004

Related U.S. Application Data
(60) Provisional application No. 60/442,425, filed on Jan. 24, 2003.

(51) Int. Cl. B32B 27/00

(52) U.S. Cl. 428/422.8; 430/457

(57) ABSTRACT

A photochromic polyurethane film of improved light fatigue resistance is disclosed. A stabilizer system combining two hindered amine light stabilizers and one phenolic antioxidant is incorporated in the photochromic polyurethane film in an amount so that the film will have more than 40% of light fatigue improvement and less than 6 units in Δb* of CIELAB system after a given light fatigue test. The film can be conveniently laminated between two transparent plastic sheets and incorporated into a plastic article.

### CROSS REFERENCE TO RELATED APPLICATIONS

This application claims the benefit of priority from U.S. Provisional Application Serial No. 60/442,425 filed on Jan. 24, 2003, the contents of which are hereby incorporated by reference.

### BACKGROUND OF THE INVENTION

1. Field of the Invention

This invention relates to a photochromic polyurethane film of improved fatigue resistance. More particularly, this invention relates to a stabilizer system, comprising two hindered amnine light stabilizers and one organic antioxidant, which is used to extend the fatigue life of photochromic compounds in a polyurethane film. This invention also relates to the application of said photochromic polyurethane films in photochromic optical articles, such as ophthalmic lenses and sport goggles.

2. Description of the Related Art

Photochromic articles, particularly photochromic plastic materials for optical applications, have been the subjects of considerable attention. In particular, photochromic ophthalmic plastic lenses have been investigated because of the weight advantage and impact resistance they offer over glass lenses. Moreover, photochromic transparencies, e.g. window sheets, for vehicles such as cars, boats and airplanes, have been of interest because of the potential safety features that such transparencies offer.

The key material components in a photochromic article are the photochromic compounds and the material that host the photochromic compounds. A photochromic compound used in the aforementioned applications exhibits a reversible dark—clear color change when exposed to and removed from light radiation involving ultraviolet (UV) light, such as sunlight. The darkening process is driven by the UV light energy, while the bleaching (fading) process is driven by thermal energy. Various classes of photochromic compounds have been synthesized and suggested for use in applications in which a sunlight-induced reversible color change or darkening is desired. The most widely described classes are oxazines, naphthopyrans and fulgides.

A common problem related to organic photochromic compounds is light fatigue, which is the gradual loss of their photochromism, i.e., the ability to change color in response to UV light and subsequently revert to their original colorless state as a result of prolonged repeated exposure to UV light. Usually, this performance fatigue is accompanied by an increase in yellowness of the photochromic article. This phenomenon is believed to be a result of transformation of the colored form into a species that is irreversible to the colorless form of the photochromic compound. Reactions such as photo-oxidation and thermo-oxidation contribute to such transformation.

Therefore, various methods have been proposed to improve the fatigue resistance of photochromic compounds. Additions of various light stabilizers, light absorbers, and organic antioxidants have been proposed. However, earlier work involves the use of only one type of stabilizers in particular photochromic compositions. U.S. Pat. No. 3,212,898, the contents of which are hereby incorporated by reference, suggests the incorporation of UV light absorbers such as hydroxybenzophenone, hydroxybenzotriazole or derivatives thereof, to lengthen the life of spiro-indolino-benzopyran type photochromic compounds in polyester host materials. A method of adding a nickel complex as the UV stabilizer was described in Japanese Patent Publication No. 58(1983)-173181, the contents of which are hereby incorporated by reference. U.S. Pat. No. 4,440,672, the contents of which are hereby incorporated by reference, discloses also addition of a nickel complex as the UV stabilizer—singlet oxygen quencher to stabilize spiro-indolino-naphthooxazine photochromic compounds in host materials including CR-39 lens material. U.S. Pat. No. 5,266,447, the contents of which are hereby incorporated by reference, describes the use of a tertiary amine to stabilize either spiropyrans or spirooxazines.

The use of only one type of stabilizer has been proven to not have enough light fatigue resistance for applications such as ophthalmic lenses. U.S. Pat. No. 5,391,327, the contents of which are hereby incorporated by reference, discloses the use of a combination of certain asymmetric diaryloxalamide (oxanilide) compounds and hindered amine light stabilizer (HALS) compounds in certain proportions and certain amounts to improve the fatigue resistance of a combination of oxazines and pyrans. Japanese patent publication No. 03-282445, the contents of which are hereby incorporated by reference, describes generally incorporating UV stabilizers commonly used for plastics in photochromic moldings for enhanced durability. Examples of classes of UV stabilizers listed are singlet oxygen quenchers, hindered amine light stabilizers, hindered phenolic antioxidants and sulfur-containing antioxidants. Japanese patent publication No. 07-48363, the contents of which are hereby incorporated by reference, describes generally improving the durability of a chromene-based photochromic material by shielding it from oxygen and water during use. In addition, the publication describes using singlet oxygen quenchers typified by nickel salts, nitroxy radical compounds, hindered amine compounds or polymers thereof and other antioxidants, ultraviolet light absorbers and triplet state quenchers to improve durability.

U.S. Pat. No. 5,699,182, the contents of which are hereby incorporated by reference, describes combinations of HALS compounds and hydroxyphenyl benzotriazole UV absorbers that have a synergistic effect in extending the usable lifetime of photochromic compositions and articles. Specifically, certain tertiary and secondary amine HALS compounds in combination with the UV absorbers extend the usable lifetime of spiro-indolino-oxazine photochromic compositions and articles. Additionally, hindered aminoether light stabilizer (HAELS) compounds by themselves surprisingly extend the usable lifetime of naphthopyran photochromic compositions and articles. Similarly, HAELS compounds in combination with the UV absorbers further extend the usable lifetime of the naphthopyran photochromic compositions and articles.

U.S. Pat. No. 5,770,115, the contents of which are hereby incorporated by reference, discloses a photochromic naphthopyran composition stabilized by a stabilizer package system which comprises (a) polyphenolic antioxidant material, (b) UV absorber and (c) HALS for said photochromic naphthopyran material. The stabilizer system is selected and used in amounts sufficient to provide at least a 30% reduction in % photopic fatigue of the naphthopyran material. The weight ratio of photochromic naphthopyran to the stabilizer system is from 2.5:1 to 1.5:1. The stabilizer system can comprise 5 to 50 weight percent of the antioxidant material, 5 to 50 weight percent of the UV absorbent, and 10 to 90 weight percent of the HALS.

U.S. Pat. No. 6,083,427, the contents of which are hereby incorporated by reference, discloses a stabilizing matrix for photochromic compounds is disclosed in which a functionalized HALS capable of reacting with an isocyanate group is linked to the polymer backbone by a covalent bond to form a grafted structure. The resulting matrix is characterized by having a stabilizing effect on the photochromic dye, in particular, spirooxazines. Preferred specific articles of the invention are photochromic organic lenses.

U.S. Pat. No. 6,547,390, the contents of which are hereby incorporated by reference, describes a stabilized photochromic lens system that utilizes for the stabilizing of napthopyran and spiroxazine photochromic dye in a coating or plastic media is presented. A two-tiered layering system is utilized in which a HALS and/or an UV absorber, is placed as a clear coat layer above a bottom layer containing the photochromic compounds. The bottom layer is constructed containing the photochromic compounds by either a coating of a surface of a lens or an imbuing of the photochromic dyes into the lens material, and can further optionally contain a HALS and/or UV blocking compound itself.

All of the above combinations include UV absorbers. UV absorbers such as hydroxybenzophenone and hydroxybenzotriazole block certain amounts of UV energy required for activating (darkening) the organic photochromic compounds. Thus, the activation intensity or darkening of the photochromic compounds(s) is reduced. This is opposite of the goal of the photochromic article which is to achieve a sunglass shading tint in outdoor illumination. Increasing the concentration of the photochromic compounds may compensate for the decrease of sensitivity, but the cost of the photochromic article is markedly increased accordingly.

Without using UV absorbers, Japanese Patent Publication No. 05-032965, the contents of which are hereby incorporated by reference, combines HALS and an organic antioxidant to stabilize spiro-oxazine photochromic compounds in cast resin materials such as poly(methyl methacrylate).

Polyurethane is used as the other key material of a photochromic system. It is a preferred host material, due to the advantageous properties it provides the photochromic compounds. Such advantageous properties include faster activation (darkening) and fading (bleaching), higher activity, and better fatigue resistance. The use of polyurethane materials is disclosed in, for example, the following U.S. Pat. Nos. 4,889,413 and 6,166129, and U.S. patent Publication No. 2002/0197484, the contents of which are all hereby incorporated by reference. Particularly, photochromic polyurethane laminates can be utilized to manufacture photochromic articles such as ophthalmic lenses using the insert injection molding process described in U.S. Pat. No. 6,328,446, the contents of which are hereby incorporated by reference.

Theoretically, the aforementioned stabilizers may be used to extend the service life of the photochromic compounds in a polyurethane material. The prior art has paid much attention to stabilizer systems that improve the light fatigue resistance of a photochromic compound in terms of photochromic activity. However, light fatigue is usually accompanied by yellowing of the photochromic composition. An ideal stabilizer system should not only preserve activity, but also prevent yellowing so as to extent the original service life of the article.

It is thus an object of the present invention to provide a photochromic polyurethane film with improved light fatigue resistance in terms of both improved photochromic activity and reduced yellowness during the useful life of the article. It has now been discovered that maximum activity remaining is not necessarily accompanied by minimum yellowing. Using a stabilizer system of a combination of two synergetic HALS compounds and one organic antioxidant, it is possible to maximize the activity and minimize the yellowness of a photochromic polyurethane film, especially when the photochromic compounds are naphthopyrans that provide a neutral or substantially neutral color, e.g., gray or brown.

### DETAILED DESCRIPTION OF THE INVENTION

Throughout the specification, the terms “bleached”, “clear”, and ”un-activated” are used interchangeably for a photochromic compound.

The photochromic polyurethane film of improved fatigue resistance in the present invention comprises a polyurethane host material, at least one photochromic compounds, and a stabilizer system consisting of two HALS compounds and one organic antioxidant.

A typical polyurethane composition consists of isocyanates, polyols, and optionally curing agents or chain extenders. Any polyurethane composition may be used to produce the polyurethane host material for photochromic compounds. The preferred functionality of the components (i.e., isocyanates, polyols, and curing agents) is between 2 and 4.

Thermoplastic polyurethanes may be made from a diisocyanate, at least one di-functional polyol, and a chain extender. The polymerization can be carried out in a one-shot fashion, that is, all starting materials are initially added into the reaction vessel. However, a prepolymer approach is more preferred in order to yield high molecular weight polyurethane. In this preferred approach, a polyurethane prepolymer is first obtained by reacting a diisocyanate stoichiometrically in excess with a polyol. A chain extender of diol or diamine is then mixed with the prepolymer. The ratio of hydroxyl or amine groups to isocyanate groups in the mixture is close to unity, but may vary from 0.98 to 1.2.

A thermoset (cross-linked) polyurethane may also be obtained with one-shot or prepolymer approach as in making thermoplastic polyurethanes. In a one-shot process, cross-linking is achieved by using at least one component having a functionality higher than 2. In a prepolymer process, Cross-linking is achieved by using a curing agent that has a functionality higher than 2, e.g., a triol or mix of a diol and a triol. Cross-linking may also be achieved by having a significant excess of diisocyanate. The excess isocyanate will form cross-linking points with urethane and urea groups to prevent the melting of the polyurethane. In addition, a polyurethane material with high heat resistance may be prepared according to the disclosure of U.S. Patent Provisional Application Serial No. 60/501,820 filed Sep. 9, 2003, the contents of which are hereby incorporated by reference.

The polyol is selected from a group consisting of polyester polyol, polyether polyol, and polycarbonate polyol. Mixtures of such polyols are also possible. The number average molecular weight of the polyols is within the range of 500 to 5,000, and preferably from 800 to 2,000. The functionality of the polyol ranges from about 2 to 4, preferably about 2.0.

Example polyether polyols include polypropylene glycol, those derived from propylene oxide and/or ethylene oxide with molecular weights of about 500 to 6000 (OH numbers of 225 to 19) based on difunctional starters such as water, ethylene glycol or propylene glycol are also preferred, polyols based on copolymers of ethylene oxide and propylene oxides, and poly(tetramethylene glycol)diols.

The suitable polyester polyols include polymerizing ε-caprolactone using an initiator such as ethylene glycol, ethanolamine and similar substances. Further suitable examples are those prepared by esterification of polycarboxylic acids. Further suitable polyester polyols include reaction products of polyhydric, preferably dihydric alcohols to which trihydric alcohols may be added and polybasic, preferably dibasic carboxylic acids. Instead of these polycarboxylic acids, the corresponding carboxylic acid anhydrides or polycarboxylic acid esters of lower alcohols or mixtures thereof may be used for preparing the polyesters. The polycarboxylic acids are preferably aliphatic or cycloaliphatic. The following are mentioned as examples: succinic acid; adipic acid; suberic acid; tetrahydrophthalic acid anhydride; hexahydrophthalic acid anhydride. Suitable polyhydric alcohols include, e.g., ethylene glycol; propylene glycol-(1,2) and -(1,3); butylene glycol-(1,4) and -(1,3); hexanediol-(1,6); octanediol-(1,8); neopentyl glycol; (1,4-bis-hydroxy-methylcyclohexane); 2-methyl-1,3-propanediol; 2,2,4-trimethyl-1,3-pentanediol; triethylene glycol; tetraethylene glycol; polyethylene glycol; dipropylene glycol; polypropylene glycol; dibutylene glycol and polybutylene glycol, glycerine and trimethlyolpropane. Preferred polyester polyols are polycaprolactone polyol and polybutylene adipate polyol.

A suitable polycarbonate polyol includes polyhexamethylene carbonate. Polycarbonates based on diols listed above are prepared by the reaction of the diol and a dialkyl carbonate as described in U.S. Pat. No. 4,160,853.

The isocyanate component is preferably an aliphatic diisocyanate. The aliphatic diisocyanate is selected from the group consisting of 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3- and -1,4-diisocyanate, 1-isocyanato-2-isocyanatomethyl cyclopentane, 1-isocyanato-3-isocyanatomethyl-3,5,5-trimethyl-cyclohexane (isophorone diisocyanate or IPDI), bis-(4-isocyanatocyclohexyl)-methane, 2,4′-dicyclohexylmethane diisocyanate, 1,3- and 1,4-bis-(isocyanatomethyl)-cyclohexane, bis-(4-isocyanato-3-methylcyclohexyl)-methane, .alpha.,.alpha.,.alpha.′,.alpha.′-tetramethyl-1,3-and/or -1,4-xylylene diisocyanate, 1-isocyanato-1-methyl-4(3)-isocyanatomethyl cyclohexane, 2,4- and/or 2,6-hexahydrotoluylene diisocyanate, and mixtures thereof. Bis-(4-isocyanatocyclohexl)-methane is the preferred diisocyanate in occurrence with the method of the present invention.

Suitable curing agents or chain extenders are low molecular weight diols and triols. Examples are 1,3-propanediol, 1,4-butanediol, 1,6-hexanediol, trimethylolpropane, glycerine, and low molecular weight (<500)polyester polyols, polyether polyols. The curing agent may also be a non-yellowing aliphatic or aromatic diamine or triamine.

A variety of catalysts known in the art maybe used for the urethane reaction. Preferably a tin catalyst is used for this purpose according to the present invention.

Some commercially available polyurethanes made from aliphatic diisocyanate can by used directly. Examples are Tecolfex aliphatic polyurethanes from Thermedics Polymers (Boston, Mass.) and SS-series from Stevens Urethane (Easthampton, Mass.)

Suitable photochromic compounds in the context of the invention are organic compounds that, in solution state, are activated (darken) when exposed to a certain light energy (e.g., outdoor sunlight), and bleach to clear when the light energy is removed. They are selected from the group consisting essentially of benzopyrans, naphthopyrans, spirobenzopyrans, spironaphthopyrans, spirobenzoxzines, spironaphthoxazines, fulgides and fulgimides. Such photochromic compounds have been reported which, for example, in U.S. Pat. Nos. 5,658,502, 5,702,645, 5,840,926, 6,096,246, 6,113,812, 6,296,785, and 6,608,215; all incorporated herein by reference.

Among the photochromic compounds identified, naphthopyran derivatives are preferred for optical articles such as eyewear lenses. They exhibit good quantum efficiency for coloring, a good sensitivity and saturated optical density, an acceptable bleach or fade rate, and most importantly good fatigue behavior. These compounds are available to cover the visible light spectrum from 400 nm to 700 nm.

More preferred are naphtho[2,1b]pyrans and naphtho[1,2b]pyrans represented by the following generic formula:

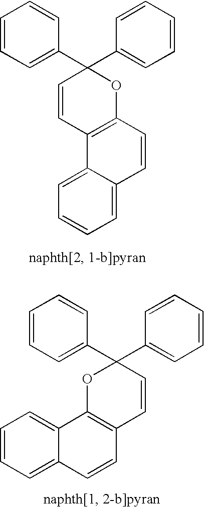

Substituents on various positions of the aromatic structure are used to tune the compounds to have desired color and fading rate, and improved fatigue behavior. For example, a photochromic dye may contain a polymerizable group such as a (meth)acryloyloxy group or a (meth)allyl group, so that it can be chemically bonded to the host material through polymerization.

The quantity of photochromic compound(s) incorporated into the polyurethane host material is determined by the desired light blockage in the activated state and the thickness of the polyurethane film. When the photochromic polyurethane film of the present invention is used in eyewear lenses, the preferred outdoor visible light transmission after activation is preferably between 10% to 50%, more preferably between 10% to 30%, most preferably between 10% to 20%. Preferably, the amount of total photochromic compounds incorporated into or applied on the polyurethane film may range from about 0.1% to about 6.0%, by weight, and more preferably from about 0.5% to about 3.0%, by weight. If the thickness of the polyurethane film is 100 μm, between about 0.5% to about 1.0%, by weight, of photochromic compound(s) is needed to achieve an outdoor light transmission in the range of from about 10% to about 20%. The amount of photochromic compound(s) needed is inversely proportional to the thickness of the polyurethane film. In other words, to achieve the same outdoor light transmission the thicker the polyurethane film, the lower the concentration of photochromic compound(s) needed. The concentration of the photochromic compound(s) also depends on the color intensity of the photochromic compound(s) at the activated state.

When the photochromic polyurethane film of the present invention is applied in articles such as eyewear lenses, it is preferred that the activated color of the photochromic compound(s) is neutral or near neutral color of gray or brown. In general, a gray or brown color can by achieved by combining one photochromic compound that exhibit an absorption peak from 420 nm to 500 nm with another photochromic compound that exhibit an absorption peak from 550 nm to 600 nm.

A wide variety of hindered amine stabilizers (HALS) may be used with this invention, including those HALS compounds reported to function as radical scavengers and that contain a 2,2,6,6-tetramethylpiperperidine ring or 2,2,6,6-tetramethylpiperperazinone. The hindered amine may be substituted or unsubstituted. Preferably, the HALS compound is selected from the group consisting of bis(2,2,6,6-tetramethyl-4-piperidinyl)sebacate, bis(1,2,2,6,6-pentamethyl-4-piperidinyl)sebacate, bis(1,2,2,6,6-pentamethyl-4-piperidinyl)-[[3,5-bis(1,1-dimethylethyl)]-[4-hydroxyphenyl]methyl]butyl malonate, 1-(methyl)-8-(1, 2,2,6,6-pentamethyl-4-piperidinyl)sebacate, 1-[2-(3-(3,5-di-t-butyl-4-hydroxyphenyl)propionyloxy)ethyl]-4-[3-(3,5-di-t-butyl-4-hydroxyphenyl)propionyloxy]-2,2,6,6-tetramethylpiperidine, 4-benzoyloxy-2,2,6,6-tetramethylpiperidine, triethylene-diamine and 8-acetyl-3-dodecyl-7,7,9,9-tetramethyl-1,3,8-triazaspiro[4,5]decane-2,4-dione. Particularly, as hindered amine light stabilizer, bis(1,2,2,6,6-pentamethyl-4-piperidinyl)sebacate or a condensation product of 1,2,2,6,6-pentamethyl-4-piperidinol and an aliphatic poly-caboxylic acid as tertiary hindered amine compound is preferable.

Some HALS such as dodecyl N-(2,2,6,6-tetramethylpiperidin-4-yl)-β-alaninate and tetradecyl N-(2,2,6,6-tetramethylpiperidin-4-yl)-β-alaninate contain an exocyclic free N—H valence. This feature provides isocyanate reactivity. If they are mixed with the polyurethane starting materials, they will be fixed to polyurethane chains after curing, thus, preventing migration. Similarly, a hydroxyl (OH) functionalized HALS can also react with isocyanate groups to chemically bond to the polyurethane chains. An oligomeric (high molecular weight) HALS is also effective in preventing migration.

There are many commercially available HALS compounds. Examples include Tinuvin HALS such as Tinuvin 144, Tinuvin 770, and Tinuvin 765 from Ciba Specialty Chemicals (Tarrytown, N.Y), Sanduvor HALS such as Sanduvor 3051, 3052, and 3055 from Clariant (Coventry, R.I).

Examples of the antioxidant include 1,1,3-tris(2-methyl-4-hydroxy-5-t-butylphenyl)butane, 2,2′-methylenebis(4-ethyl-6-t-butylphenol), tetrakis-(methylene-3-(3′,5′-di-t-butyl-4′-hydroxyphenyl)propionate]methane, 2,6-di-t-butyl-p-cresol, 4,4′-butylidenebis(3-methyl-6-t-butylphenol), 1,3,5-tris(3′-5′-di-t-butyl-4′-hydroxybenzyl)-S-triazine-2,4,6-(1H,3H,5H)trione, stearyl-β-(3,5-di-t-butyl-4-hydorxyphenyl)propionate, 1,3,5-tris(4-t-butyl-3-hydroxy-2,6-dimethylbenzyl)isocyanuric acid, 4,4′-thiobis(3-methyl-6-t-butylphenol) and 1,3,5-trimethyl-2,4,6-tris(3,5-di-t-butyl-4-hydroxybenzyl)benzene. Particularly, as phenol antioxidant, 1,1,3-tris(2-methyl-4-hydorxy-5-t-butylphenyl)butane, tetrakis-[methylene-3-(3′,5′-di-t-butyl-4′-hydroxy-phenyl)propionate]methane and 1,3,5-tris(3,5-di-t-butyl-4-hyroxybenzyl)-1,3,5-triazine-2,4,6-(1H,3H,5H)-trione which contain 3 or above of hindered phenol are preferable.

Suitable commercially antioxidant compounds are Irganox 1010, 1076, and 1135 from Ciba Specialty Chemicals (Tarrytown, N.Y).

The criteria used to evaluate the effectiveness of a stabilizer system are the percent improvement, % improve, in fatigue resistance and yellowness increase, Δb*, in the CIELAB L*,a*,b* color coordinate system after a light fatigue test. Their definitions and the conditions for the light fatigue test are set forth in the example section. The higher the value of % improve and the lower the value of Δb*, the better the light fatigue resistance.

The two criteria, % improve and Δb*, are used to give a more objective evaluation of useful service life of a photochromic polyurethane film. Over the service course of the film, not only its photochromic activity is need, but also less discoloration (e.g., yellowing) is desired. The Inventors found that, as will be seen in the examples, although some stabilizers provide high % improve, but Δb* is also high. Surprisingly, the combination of two hindered amine stabilizers and one phenolic antioxidant not only provide high % improve but also minimize Δb*.

In accordance with the present invention, the light fatigue resistance of a photochromic polyurethane film is improved by incorporating an effective amount of a stabilizer system into the film. The stabilizer system is particularly a combination of one phenolic antioxidant and two hindered amine light stabilizers. They are used in an amount that provides at least 40% improvement in fatigue resistance (% improve) and less than 6-unit change in yellowness (Δb*) under the specified fatigue test.

The total weight percent of the stabilizer system in the photochromic polyurethane ranges from 1% to 9%, and preferably ranges from 3% to 6%. The phenolic antioxidant (AO) counts for about 10% to 90%, by weight, of the total weight of the stabilizer system, and the two hindered amine light stabilizes (HALS) make up about 10% to 90%, by weight. Preferably, the stabilizer system comprises, in percent weight, 10% to 40% AO and 60% to 90% HALS.

Depending on how the photochromic polyurethane film will be formed, there are variety of ways to incorporate the stabilizers and the photochromic compounds into the film. A polyurethane film can be formed by in-situ polymerization or curing. The polyurethane can be either thermoplastic or cross-linked. Photochromic compounds, stabilizers, and a curing catalyst are added into the polyurethane liquid starting materials and mixed well. The mixture is coated on a substrate such as a release liner, and then cured into a film. More preferably, the mixture is directly laminated between two substrates such as transparent plastic sheets and cured into a photochromic laminate. The curing is usually carried out under heat, e.g., 40° C. to 120° C. The starting materials consist of at least one isocyanate compound, at least one polyol, and at least one low molecular weight chain extender or curing agent. The isocyanate usually has a functionality of 2. If cross-linking is desired, it may be introduced by a tri-functional alcohol or amine chain extender. A polyurethane prepolymer end-capped with isocyanate groups can be used to replace the isocyanate compound. In case that it is hard to directly dissolve the additives into the starting materials, an anhydrous solvent such as tetrahydrofuran is used. The additives are first dissolved in the solvent, and then mixed together with the starting materials.

Another method to form a photochromic polyurethane film is solution casting. In this method, a thermoplastic polyurethane is first prepared. Selected photochromic compounds, stabilizers, and the polyurethane are dissolved in a suitable solvent or in a mix of solvents to produce a solution. The solution is then cast on a release liner and dried. It is desirable to keep solvent retention in the polyurethane film at a minimum level. The weight percent solvent retention should preferably be less than 2%, more preferably less than 1%. Conventional methods such as hot air dryers may be used to evaporate the solvent.

The polyurethane solution usually contains 10% to 60%, by weight, of solid. It may be cast with methods known to those skilled in the art, including knife-over-roll, reverse-roll, gravure, etc. If the solvent selected to dissolve the polyurethane does not whiten the substrate resin sheet to be laminated on, a direct cast on the resin sheet may be employed.

Examples of suitable solvents that may be used to dissolve polyurethanes include cyclohexane, toluene, xylene and ethyl benzene, esters such as ethyl acetate, methyl acetate, isopropyl acetate, n-propyl acetate, isobutyl acetate, n-butyl acetate, isoamyl acetate, methyl propionate and isobutyl propionate, ketones such as acetone, methylethyl ketone, diethyl ketone, methylisobutyl ketone, acetyl acetone and cyclohexyl ketone, ether esters such as cellosolve aetate, diethylglycol diaetate, ethyleneglycol mono n-butylether acetate, propylene glycol and monomethylether acetate, tertiary alcohols such as diacetone alcohol and t-amyl alcohol and tetrahydrofuran. Ethyl acetate, methyl ethyl ketone, tetrahydrofuran, toluene and combinations thereof are preferable.

Yet another method to form a photochromic polyurethane film with the stabilizer system is by extrusion. The photochromic film from a thermoplastic polyurethane is extruded through, for example, a screw extruder. The photochromic compounds and stabilizers may be incorporated into the polyurethane during the resin synthesis stage or melt-mixed prior to or during extrusion.

A cast or extruded photochromic polyurethane film can then be laminated between two transparent resin sheets to provide a photochromic laminate plate. For most thermoplastic polyurethanes, hot-lamination at a temperature close to the softening point should provide sufficient adhesion so that no additional adhesive is needed,

Still another method to have a photochromic polyurethane film with the stabilizer system is by imbibition. A polyurethane film is formed with the aforementioned methods. Imbibition of the additives (photochromic compound and stabilizers) into the polyurethane film is accomplished by immersion of the film in a hot solution of the additives or by thermal transfer. The imbibition may also be accomplished by providing the additives in a coating and applying the coating on the polyurethane film. The term “imbibition” is intended to mean and include permeation of the additives alone into the polyurethane host material, solvent assisted transfer of the additives, vapor phase transfer, and other such transfer mechanisms. The photochromic compound and the individual materials of the stabilizer system may be imbibed separately or together. They may even be incorporated into the polyurethane material through different routes. For example, the imbibition may be only applied to photochromic dyes while the stabilizers are incorporated in the polyurethane material with other aforementioned methods.

The thickness of the photochromic polyurethane film is preferred to be in the range of about 10 μm to about 250 μm. The thickness variation of the photochromic polyurethane layer should be controlled in order to produce a uniform light blockage at the activated state. A thickness variation of less than 20% over the width of the laminate is required and preferably less than 15% and more preferably less than 10%.

Compatible tints (chemical and color), i.e., dyes, may also be incorporated into the polyurethane film to achieve a more aesthetic result, for medical reasons, or for reasons of fashion. The particular dye selected will vary and depend on the aforesaid need and result to be achieved. For instance, the dye may be selected to complement the color resulting from the activated photochromic compounds, or to provide a desired hue to the host matrix when the photochromic compounds are in the unactivated state.

The transparent photochromic laminate prepared from a photochromic polyurethane film according to the present invention is especially suitable for making photochromic plastic articles such as a lens through the insert injection molding process described in commonly assigned U.S. Pat. No. 6,328,446, the contents of which are hereby incorporated by reference. The laminate can also be used as-is for other photochromic transparencies such as goggles and face shields. The photochromic laminate may also be incorporated into other types of eyewear lenses such as cast resin lenses. In the case of cast resin lenses, the laminate is usually formed as a curved wafer having a spherical surface. The wafer can then be integrated with the lens base material by insert casting as described in U.S. Pat. No. 5,286,419, the contents of which are hereby incorporated by reference.

### EXAMPLES

The light fatigue for the photochromic polyurethane film of the present invention is tested by exposing the sample film of about 150 μm thick to a Xenon Solar Simulating Lamp with an intensity of 30 watts/m² in the 300 nm to 400 nm spectral range, for a continuous period of 144 hours. The light transmission spectrum from 400 nm to 700 nm is recorded for the unactivated and activated states of the sample, before and after the 144-hour light fatigue and the Luminous Transmission is calculated. The photochromic activity of a given photochromic film is expressed in terms of optical density difference (ΔOD) between the inactivated and activated states:

ΔOD=log(T_{U}/T_{A})

Where T_{U} is the Luminous Transmission at the unactivated state, and T_{A} is theLuminous Transmission at the activated state. Thus, the percent activity remaining, % A, is calculated as the ratio between ΔOD after and before the 144-hour fatigue:

$$\% A = \frac{{( Δ OD )}_{144}}{{( Δ OD )}_{0}} * 100$$

The percent fatigue, % F, is 100 minus % A. The percent improvement, % Improve, of light fatigue resistance for a sample with stabilizers is calculated as the ratio of % F difference between the non-stabilized sample and the stabilized sample versus the % F of the non-stabilized sample. The higher the % improve, the better the light fatigue resistance.

The b* color coordinate of CIELAB is recorded for the unactivated state of the sample before and after the 144-hour light fatigue. The yellowness change of the sample is expressed in Δb*, the difference between the b* value before and after the fatigue. It is desired to have minimal change in b*, especially <6.0.

The light transmission spectrum and color coordinate b* of CIELAB are measured by using a Hunter Lab UltraScan spectrophotometer.

The activation is done by exposing the photochromic film to a Xenon Solar Simulating Lamp with an intensity of 12 watts/m² in the 300 nm to 400 nm spectral range, for 5 minutes.

HALS-1: bis(1,2,2,6,6-pentamethyl4-piperidinyl)-[[3,5-bis(1,1-dimethylethyl)]-[4-hydroxyphenyl]methyl]butyl malonate.

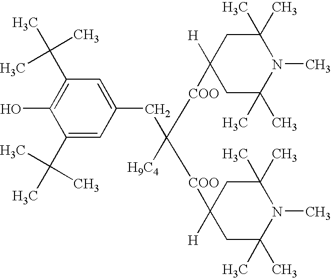

It is available from Ciba Specialty Chemicals as Tinuvin 144.

HALS-2: mixture of Bis(1,2,2,6,6-pentamethyl-4-piperidinyl)sebacate and methyl(1,2,2,6,6-pentamethyl-4-piperidinyl)sebacate.

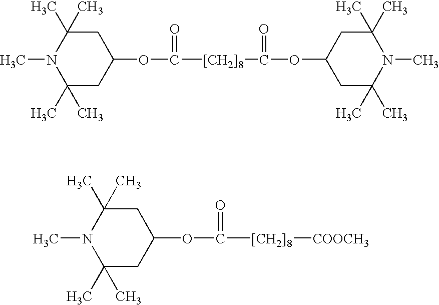

It is available from Ciba Specialty Chemicals as Tinuvin 765, and from Cytec as Cyasorb UV-3765.

AO-1:tetrakis-(methylene-3(3′,5′-di-t-butyl-4′-hydroxyphenyl)propionate]methane.

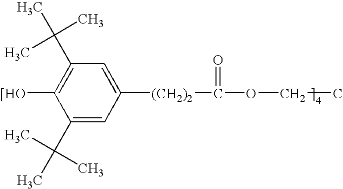

It is available from Ciba Specialty Chemicals as Irganox 1010.

Dye-1: a[2,1-b]naphthopyran compound having maximum visible light absorption at 470 nm (yellow) in the polyurethane host material used in the examples.

Dye-2: a [1,2-b]naphthopyran compound having maximum visible light absorption at 580 nm (blue) in the polyurethane host material used in the examples.

### Examples 1-8

To a solution of 18%, by weight, of an aliphatic, polyester polyurethane (Tecoflex CLC-93A from Thermedics Polymer Products, Mass.) in tetrahydrofuran was added given amount of HALS-1, HALS-2, and AO-1, and 0.1% of Dye-1 and 0.7% of Dye-2. The mixture was then cast on a flat glass plate and the solvent allowed to evaporate. A photochromic polyurethane film of about 150 μm thick was obtained. Films with different amount of stabilizers are listed in Table 1, along with the results of the 144-hour fatigue test. As can be seen, best overall result is obtained by the combination of the three stabilizers.

### Example 9

To a solution of an aliphatic diisocyanate, a polyester polyol, a chain extender, and a catalyst (proprietary formula of Thermedics Polymer Products, Mass.) was added 2% each of HALS-1, HALS-2, and AO-1, and 0.1% of Dye-1 and 0.7% of Dye-2. The mixture was reacted such that an aliphatic polyester polyurethane was obtained. The resulting polyurethane is palletized and extruded into a film that was about 180 μm thick. The film was then laminated between two polycarbonate sheets of 0.4 mm thick, and molded to the front of a lens described in U.S. Pat. No. 6,328,446. The remaining photochromic activity after 144-hour fatigue was 92%.

TABLE 1

| Sample | HALS-1 | HALS-2 | AO-1 | % A | % Improve | Δb* |
|---|---|---|---|---|---|---|
| Control | 0 | 0 | 0 | 70 | | 15.0 |
| 1 | 0 | 2 | 0 | 93 | 77 | 8.3 |
| 2 | 2 | 0 | 0 | 86 | 53 | 12.3 |
| 3 | 0 | 0 | 0.5 | 82 | 40 | 13.9 |
| 4 | 0 | 0 | 2 | 85 | 50 | 13.8 |
| 5 | 0 | 0 | 8 | 85 | 50 | 8.7 |
| 6 | 2 | 2 | 0.5 | 95 | 83 | 5.5 |
| 7 | 2 | 2 | 2 | 92 | 73 | 5.3 |
| 8 | 4 | 4 | 4 | 86 | 53 | 4.2 |

*Numbers for HALS-1, HALS-2, and AO-1 are weight percent.

What is claimed is:

1. A photochromic polyurethane film comprising:
a polyurethane film having a thickness in the range of about 10 μm to 250 μm;
at least one organic photochromic compound;
a stabilizer system having two hindered amine light stabilizers and one phenolic antioxidant;
said photochromic compound having a concentration of approximately 0.1 % to 6% by weight;
said stabilizer system having a concentration of approximately 1 % to 9% by weight;
said stabilizer system having a formulation to provide at least a 40% of improvement in the light fatigue resistance of the photochromic polyurethane film over a film not having said formulation; and
said stabilizer system having a formulation to provide a change of less than 6 units in b* of CIELAB at the clear state for said photochromic polyurethane film.

2. A photochromic polyurethane film of claim 1 wherein said stabilizer system comprises:
(a) 60% to 90%, by weight, two hindered amine light stabilizers being selected from the group consisting of bis(1,2,2,6,6-pentamethyl-4-piperidinyl)-[[3,5-bis(1,1-dimethylethyl)]-[4-hydroxyphenyl]methyl]butyl malonate; Bis(1,2,2,6,6-pentamethyl-4-piperidinyl)sebacate; methyl(1,2,2,6,6-pentamethyl-4-piperidinyl)sebacate; bis(2,2,6,6-tetramethyl4-piperdinyl)decanedioate; 1-acetyl4-(3-dodecyl-2,5-dioxo-1-pyrrolidinyl)-2,2,6,6-tetramethyl-piperi dine and N-unsubstituted HALS compounds, N-methylated HALS compounds.
(b) 10% to 40%, by weight, one phenolic antioxidant being selected from the group consisting of tetrakis-(methylene-3-(3′′,5′′-di-t-butyl-4′-hydroxyphenyl)propionate]methane; 1,3,5-trimethyl-2,4,6-tris(3,5-di-tert-butyl-4′-hydroxybenzyl)benzene; 1,3,5-tris(3,5-di-tert-butyl-4′-hydroxybenzyl)isocyanurate; 3,5-di-tert-butyl-4-hydroxyhydrocinnamic triester with 1,3,5-tris(2-hydroxyethyl)s-triazine-2,4,6-(1 H,3H,5H)-trione; 1,3,5-tris(4-tert-butyl-3-hydroxy-2,6-dimethylbenzyl)s-triazine-2,4,6-(1H, 3H,5H)-trione;

3. A photochromic polyurethane film of claim 2 wherein said two hindered amine light stabilizers are bis(1,2,2,6,6-pentamethyl-4-piperidinyl)-[[3,5-bis(1,1-dimethylethyl)]-[4-hydroxyphenyl]methyl]butyl malonate and Bis(1,2,2,6,6-pentamethyl-4-piperidinyl)sebacate-methyl(1,2,2,6,6-pentamethyl-4-piperidinyl)sebacate, and said phenolic antioxidant is tetrakis-(methylene-3-(3′,5′-di-t-butyl-4′-hydroxyphenyl)propionate]methane.

4. A photochromic polyurethane film of claim 1 wherein said photochromic compound is a photochromic naphthopyran.

5. A photochromic polyurethane film of claim 1 wherein said polyurethane is an aliphatic polyurethane.

6. A photochromic polyurethane film of claim 1 wherein said polyurethane is an aliphatic polyester polyurethane.

7. A photochromic polyurethane film of claim 1 wherein the film is laminated.

8. A photochromic polyurethane film of claim 7 wherein the laminate is incorporated into an eyewear lens.
